(19) United States
(12) Patent Application Publication
(10) Pub. No.: US 2026/0358168 A1
(43) Pub. Date: Nov. 12, 2026

(54) CHUTE FOR WEIGHING A RUBBER MIXTURE

(71) Applicant: COMPAGNIE GENERALE DES ETABLISSEMENTS MICHELIN, Clermont-Ferrand (FR)

(72) Inventor: JEROME MOUSSIER, Clermont-Ferrand (FR)

(21) Appl. No.: 19/136,024

(22) PCT Filed: Nov. 30, 2023
(86) PCT No.: PCT/EP2023/083805

§ 371 Date: Jun. 5, 2025

(30) Foreign Application Priority Data
Dec. 6, 2022 (FR) 2212816

(51) Int. Cl. G01G 19/14; G01G 17/04

(52) U.S. Cl. CPC G01G 19/14; G01G 17/04

(57) ABSTRACT

A weighing chute (10) comprises a fixed main frame (18), a movable secondary frame (20), a receiving hopper (14) for receiving a mixture to be weighed, fixedly mounted on the secondary frame, and weighing sensors (22). Vibration dampers (30) are interposed between the main frame and the secondary frame, and the weighing sensors are mounted movably relative to the main frame between a rest position in which the secondary frame and the receiving hopper rest on the vibration dampers and do not rest on the weighing sensors, and a weighing position in which the secondary frame and the receiving hopper rest on the weighing sensors and do not rest on the vibration dampers.

The present invention relates to the weighing of a rubber mixture, in particular at the outlet of an internal mixer.

In the manufacturing of tyres, various rubber mixtures are produced in internal mixers, from various products: carbon black, natural and/or synthetic rubber, chemicals, oils, etc.

If the various mixed products are weighed or dispensed upstream of the internal mixer, it is also necessary to weigh the mixture at the outlet of the internal mixer to check the weighing and dispensing carried out upstream and to ensure that no mixture remains in the internal mixer.

Document CN 104441297 describes a weighing chute adapted to be placed under an internal mixer.

A first drawback of the solution disclosed in this document CN 104441297 lies in the attachment of the frame 2 of the weighing chute under an internal mixer via attachment flanges 1. To be specific, an internal mixer generates vibration liable to interfere with the measurements taken by the weighing sensors of the weighing chute.

Another drawback of the solution disclosed in document CN 104441297 is that, because they are suspended from the internal mixer, the weighing chute and its frame 2 may also transmit vibration or shocks to the internal mixer when the mixture falls from the internal mixer towards the weighing chute. This transmission of vibration or shocks from the weighing chute to the internal mixer is not desirable because it can gradually damage the attachment of the internal mixer to its own frame or certain components of the mixer.

Document CN 104441297 provides for the installation of rubber seals to attenuate the transmission of vibration between the mixer and the weighing chute. However, given the mass of the mixtures to be weighed, a few hundred kilogrammes, and the mass of the weighing chute and its frame, several hundred kilogrammes, these simple rubber seals are not sufficient to attenuate vibration quickly and effectively. Moreover, such seals do not make it possible to fully absorb the shock and significant kinetic energy generated by the fall of a mixture weighing a few hundred kilogrammes into the weighing chute. Also, in the solution presented in document CN 104441297, it is the cylinders 5 provided between the frame 2 and the mixing receptacle 6 which must absorb this kinetic energy each time a new mixture is dropped, whereas these actuators are generally not designed to withstand such repeated shocks and they risk being damaged very quickly with such use.

Document CN 104441297 also provides for the insertion of vibration absorbers 4 between the mixing receptacle 6 and the weighing sensors 3. However, these vibration absorbers 4 are no use when the mixture falls into the receptacle 6 because, at that time, the receptacle is resting on the cylinders 5 and not on the weighing sensors.

The present invention aims to overcome the drawbacks of the prior art by proposing an arrangement of a weighing chute offering better management of the vibration and shocks that may be generated during the use of such a weighing chute, for example for weighing a rubber mixture falling from an internal mixer. At the same time, the invention also aims to provide a weighing solution that offers better weighing performance, particularly in terms of time required for weighing, weighing resolution, and reliability and repeatability of measurements.

To this end, the invention relates to a weighing chute for weighing a mixture, in particular a rubber mixture, for example one coming from an internal mixer, the weighing chute comprising a fixed main frame, a movable secondary frame, a receiving hopper for receiving a mixture to be weighed, fixedly mounted on the secondary frame, and weighing sensors.

According to the invention, vibration dampers are interposed between the main frame and the secondary frame, and the weighing sensors are mounted movably relative to the main frame between a rest position in which the secondary frame and the receiving hopper rest on the vibration dampers and do not rest on the weighing sensors, and a weighing position in which the secondary frame and the receiving hopper rest on the weighing sensors and do not rest on the vibration dampers.

In the weighing chute according to the invention, the vibration dampers are devices dedicated to absorbing shocks and vibration. These dampers do not have a lifting function that could be impaired by the repeated shocks and vibration caused by receiving a product weighing several hundred kilogrammes, such as a rubber mixture intended for the manufacture of tyres.

Advantageously, but not necessarily, the invention may also provide that:
the weighing sensors are mounted on a raising and lowering device mounted on the main frame, the raising and lowering device making it possible to bring the weighing sensors from their rest position to their weighing position, and from their weighing position to their rest position,
the raising and lowering device allows the weighing sensors to be moved such that the weighing position of the weighing sensors is above their rest position,
the weighing sensors are located above the vibration dampers when these weighing sensors are in their weighing position,
more specifically, the weighing surfaces of the weighing sensors are located above the receiving surfaces of the vibration dampers when these weighing sensors are in their weighing position,
the weighing chute comprises a control device for checking the measurements taken by the weighing sensors,
the control device comprises means for applying a predetermined force to the secondary frame when the weighing sensors are in their weighing position.

The invention also relates to a facility for producing a rubber mixture, for example in a tyre manufacturing plant, comprising an internal mixer for producing a rubber mixture and a weighing chute according to the invention and located under this internal mixer for weighing the mixture produced by the mixer. Advantageously, the main frame of the weighing chute is independent of the frame on which the internal mixer is mounted.

Further features and advantages of the invention will become apparent from the following description. This description, which is provided by way of non-limiting example, refers to the appended schematic drawings, in which:

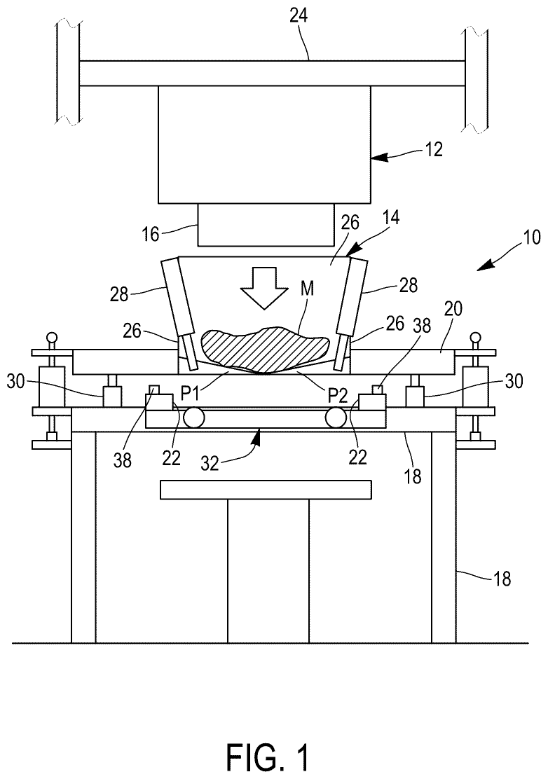

FIG. 1 depicts the reception of a product to be weighed in a weighing chute according to the invention,

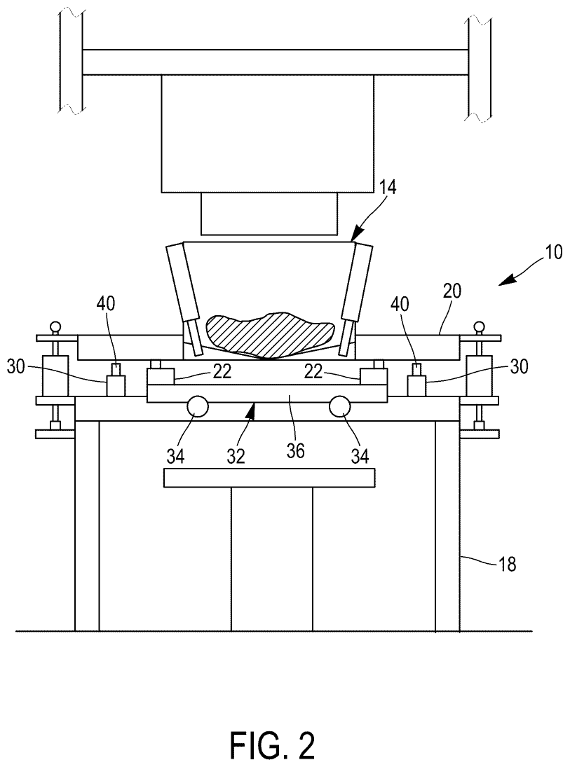

FIG. 2 depicts the weighing of a product to be weighed with a weighing chute according to the invention,

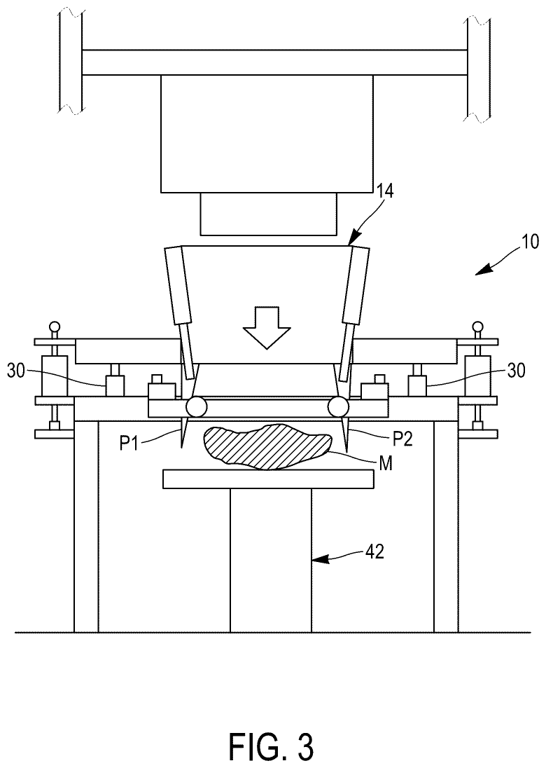

FIG. 3 depicts the unloading of the product after weighing with a weighing chute according to the invention,

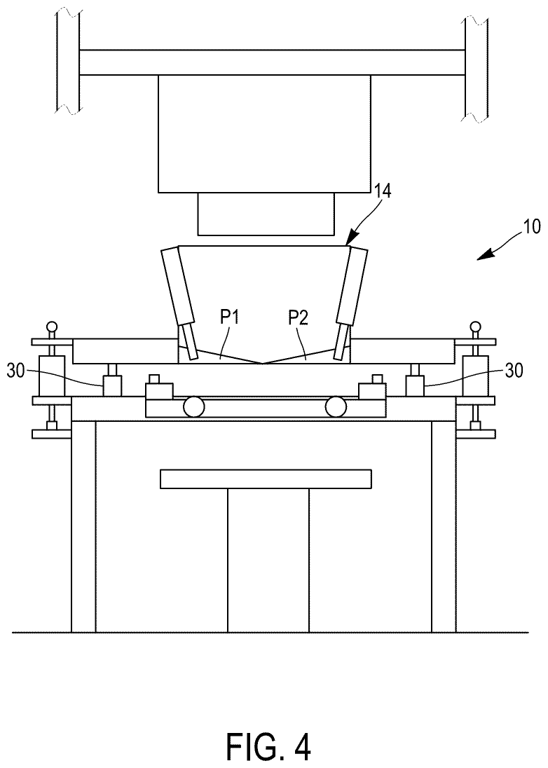

FIG. 4 depicts the configuration for receiving a product to be weighed of a weighing chute according to the invention,

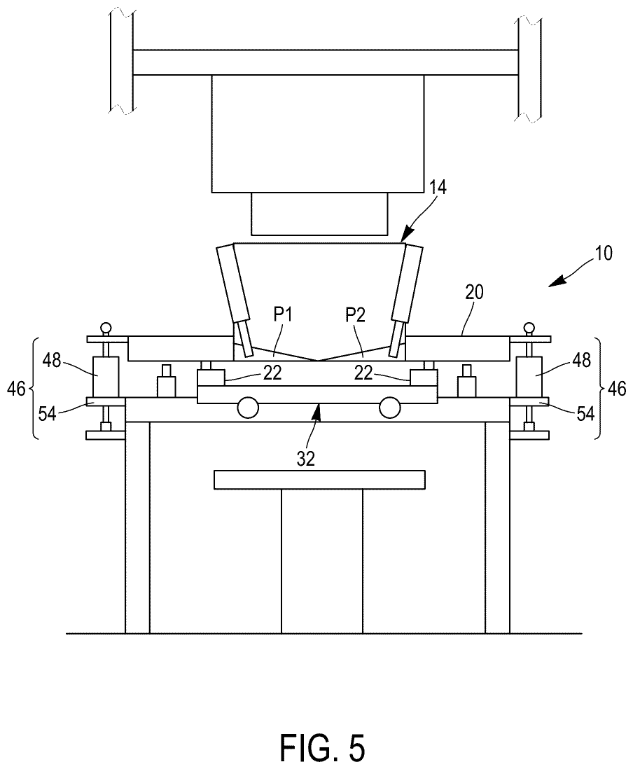

FIG. 5 depicts a step of checking that there is no product to be weighed in a weighing chute according to the invention,

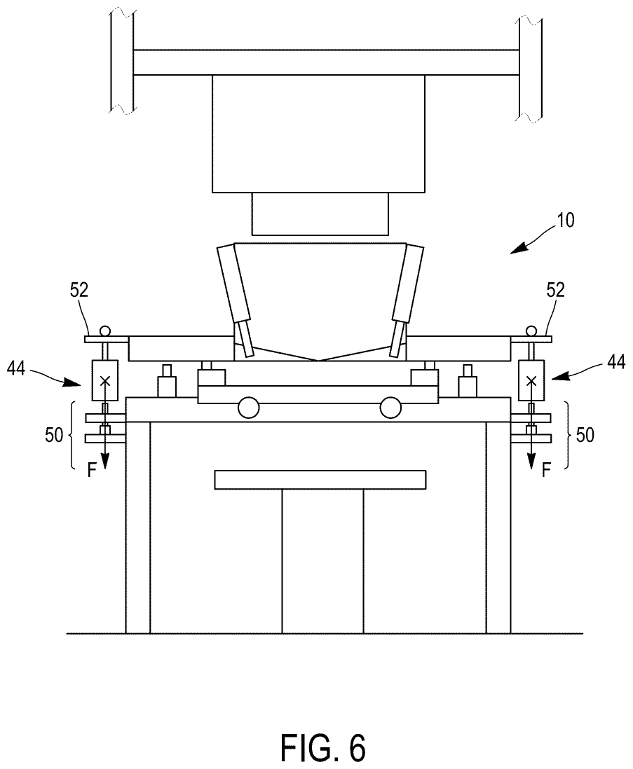

FIG. 6 depicts a step of verifying the measurements taken by the weighing sensors of a weighing chute according to the invention.

The invention relates to a weighing chute intended in particular for weighing rubber mixtures produced by internal mixers. In the context of this use, and as shown in FIG. 1, the weighing chute 10 is preferably arranged under the internal mixer 12 which produces the mixture to be weighed. In more detail, the weighing chute 10 comprises a receiving hopper 14 for receiving a mixture to be weighed and the internal mixer 12 comprises an outlet 16 for discharging the mixture, the receiving hopper 14 is positioned under the discharge outlet 16 of the internal mixer.

The weighing chute 10 according to the invention comprises a fixed main frame 18, a movable secondary frame 20, and weighing sensors 22. The receiving hopper 14 for receiving a mixture to be weighed is fixedly mounted on the secondary frame 20.

To prevent the transmission of vibration or shocks between the internal mixer 12 and the weighing chute 10, the main frame 18 of the weighing chute is independent of the frame 24 on which the internal mixer is mounted.

To receive a mixture M under an internal mixer, the receiving hopper 14 is open at the top. This receiving hopper 14 is for example of parallelepiped shape and comprises side walls 26 forming a parallelepiped. The bottom of the hopper 14 may be closed to receive the mixture M to be weighed, or open to discharge the mixture M after weighing. To this end, the receiving hopper 14 preferably comprises at the bottom two doors P1, P2 arranged in opposition and mounted rotatably relative to the side walls 26 of the chute. For example, these doors P1, P2 are rotated by cylinders 28. For example, the door actuating cylinders 28 are pneumatic to promote speed of opening/closing and locking/unlocking of the doors P1, P2, and to make it possible to absorb the shock when a mixture falls onto the closed doors P1, P2.

To limit the mass of the receiving hopper 14, the side walls 26 of the hopper are for example made from an aluminium-based alloy. By limiting the mass of the hopper, it is possible to use weighing sensors 22 with better resolution or sensitivity which therefore offer better measurement accuracy. However, to ensure mechanical resistance to the shocks generated by the repeated fall of the mixtures M into the hopper 14, the doors P1, P2 are preferably made of steel.

Advantageously, the door P1, P2 actuating cylinders 28 and the doors P1, P2 make it possible to absorb some of the kinetic energy transmitted to the secondary frame and to the main frame of the chute when a mixture M falls into the receiving hopper 14.

According to the invention, and to best absorb the vibration and shocks which may be transmitted between the internal mixer and the weighing chute, vibration dampers 30 are interposed between the main frame 18 and the secondary frame 20 on which the receiving hopper 14 is mounted.

The vibration dampers 30 are preferably viscoelastic dampers, for example made using a silicone elastomer. These dampers 30 do not offer a lifting function and do not require any mechanical return spring or additional return gas. By virtue of their viscoelastic design, these dampers fully absorb the energy released by the shock of a mixture falling into the hopper and they quickly and effectively reduce vibration and the propagation thereof to the main frame 18 of the chute. For example, the vibration dampers 30 are dampers from the BC1N range sold by the company ENIDINE®.

As the hopper 14 is parallelepiped for example, the weighing chute 10 comprises four vibration dampers 30, one at each lower corner of the receiving hopper 14.

Still according to the invention, the weighing sensors 22 are mounted movably relative to the main frame 18 of the chute between a rest position, shown in FIG. 1, in which the secondary frame 20 and the receiving hopper 14 rest on the vibration dampers 30 and do not rest on the weighing sensors 22, and a weighing position, shown in FIG. 2, in which the secondary frame 20 and the receiving hopper 14 rest on the weighing sensors 22 and do not rest on the vibration dampers 30.

For movability relative to the main frame 18 of the chute, the weighing sensors 22 are for example mounted on a raising and lowering device 32 mounted on the main frame 18, the raising and lowering device 32 making it possible to bring the weighing sensors 22 from their rest position to their weighing position, and from their weighing position to their rest position. For example, the raising and lowering device 32 comprises eccentrics 34 mounted rotatably relative to the main frame 18 and a platform 36 mounted on the eccentrics 34 and on which the weighing sensors 22 are mounted. For example, the eccentrics 34 are rotated by an electric motor via a pulley and belt transmission (not shown). The eccentrics 34 make it possible to drive the platform 36 in a combined rotational and translational movement which makes it possible to increase or reduce the relative height of the weighing sensors 22 with respect to the main frame 18. More generally, the raising and lowering device 32 allows the weighing sensors 22 to be moved such that the weighing position of the weighing sensors is above their rest position.

According to the invention, in the weighing position of the weighing sensors, the receiving hopper 14 and the secondary frame 20 rest only on the weighing sensors. To this end, the weighing sensors 22 are located above the vibration dampers 30 when these weighing sensors are in their weighing position. More specifically, the weighing surfaces 38 of the weighing sensors are located above the receiving surfaces 40 of the vibration dampers when these weighing sensors 22 are in their weighing position.

As the hopper 14 is parallelepiped for example, the weighing chute 10 comprises four weighing sensors 22, one at each lower corner of the receiving hopper 14. For example, the weighing chute 10 comprises two raising and lowering devices 32 arranged on either side of the hopper 14, two weighing sensors 22 being mounted on the platform 36 of each raising and lowering device 32.

For example, the weighing sensors 22 offer a resolution of 6000 points corresponding to a measurement interval of approximately 20 g. Preferably, the weighing sensors are bend sensors. For example, these weighing sensors comprise a flexural double built-in beam, the deformation of which is measured by gauges mounted in a Wheatstone bridge and the imbalance of which is proportional to the load to be measured.

Once weighed by the weighing sensors 22, the mixture M is for example discharged via a discharge device 42 positioned under the weighing chute 10, and more specifically under the doors P1, P2 of the weighing chute, as shown in FIG. 3. During this discharge of the mixture M, as during the reception of the mixture M, the receiving hopper 14 rests on the vibration dampers 30. Optionally, the discharge device 42 may be a device for shaping the mixture M, such as a calender or an extruder.

According to the invention, the method for weighing a mixture M carried out with the weighing chute 10 comprises the following steps, shown in FIGS. 1 to 4 respectively:
reception of the mixture M in the receiving hopper 14, the hopper 14 and the secondary frame 20 resting on the vibration dampers 30, and the doors P1, P2 of the hopper being closed,
implementation of the raising and lowering device(s) 32 such that the hopper 14 containing the mixture M and the secondary frame 20 rest on the weighing sensors only, the doors P1, P2 of the hopper still being closed, and implementation of the weighing by the weighing sensors 22,
implementation of the raising and lowering device(s) 32 such that the hopper 14 containing the mixture M and the secondary frame 20 no longer rest on the weighing sensors 22 but on the vibration dampers 30, and opening of the doors P1, P2 of the receiving hopper 14 in such a way as to discharge the weighed mixture M to the discharge device 42,
closing of the doors P1, P2 of the receiving hopper 14 so as to allow the reception of a new mixture M to be weighed, the hopper 14 and the secondary frame 20 still resting on the vibration dampers 30.

Advantageously, the weighing method may also include an additional step of weighing the empty hopper after discharge of the weighed mixture M and before reception of a new mixture M to be weighed. This step, shown in FIG. 5, aims in particular to check that no mixture remains in the hopper 14. To implement this additional step, the raising and lowering device(s) 32 are implemented such that the empty hopper 14 and the secondary frame 20 rest on the weighing sensors 22 only.

In parallel with this control step or at a predetermined frequency, corresponding for example to several cycles of measurement of different successive mixtures, the weighing method may also include a step of verifying the measurements taken by the weighing sensors of the weighing chute 10 according to the invention. To this end and as shown in FIG. 6, the weighing chute 10 may comprise a control device 44 for checking the measurements taken by the weighing sensors. For example, this control device 44 comprises means for applying 46 a predetermined force F to the secondary frame 20 when the weighing sensors 22 are in their weighing position. These means for applying 46 a force F for example take the form of weights 48 that may be secured to or removed from the secondary frame 20 by an actuation system 50. For example, the frame 20 comprises link arms 52 from which the weights 48 are suspended only when the actuation system 50 so allows. For example, an actuation system 50 is a support plate 54 moved in vertical translation by a motorized screw drive. The support plate 54 supports the weight(s) 48 to remove them from the secondary frame 20 and no longer supports the weight(s) 48 to secure them to the secondary frame 20. For example, two weights 48 are provided on either side of the receiving hopper 14, it being possible for two weights 48 to be secured to or removed from the secondary frame 20 by the same actuation system 50. These weights 48, when they are supported by the secondary frame 20 and this secondary frame 20 and the receiving hopper 14 rest on the weighing sensors 22, make it possible to apply a known force F to the weighing sensors, via the secondary frame 20, and thus to verify their measurement accuracy.

Lastly, the invention also relates to a facility for producing a rubber mixture, for example in a tyre manufacturing plant, comprising an internal mixer 12 for producing a rubber mixture and a weighing chute 10 located under this internal mixer 12 for weighing a mixture M produced by the internal mixer.

1.-9. (canceled)

10. A weighing chute for weighing a mixture comprises:
a fixed main frame;
a movable secondary frame;
a receiving hopper for receiving a mixture to be weighed, fixedly mounted on the secondary frame;
weighing sensors; and
vibration dampers,
wherein the vibration dampers are interposed between the main frame and the secondary frame, and
wherein the weighing sensors are mounted movably relative to the main frame between a rest position, in which the secondary frame and the receiving hopper rest on the vibration dampers and do not rest on the weighing sensors, and a weighing position in which the secondary frame and the receiving hopper rest on the weighing sensors and do not rest on the vibration dampers.

11. The weighing chute according to claim 10, wherein the weighing sensors are mounted on a raising and lowering device mounted on the main frame, the raising and lowering device making it possible to bring the weighing sensors from the rest position to the weighing position, and from the weighing position to the rest position.

12. The weighing chute according to claim 11, wherein the raising and lowering device allows the weighing sensors to be moved such that the weighing position of the weighing sensors is above the rest position of the weighing sensors.

13. The weighing chute according to claim 12, wherein the weighing sensors are located above the vibration dampers when the weighing sensors are in the weighing position.

14. The weighing chute according to claim 13, wherein weighing surfaces of the weighing sensors are located above receiving surfaces of the vibration dampers when the weighing sensors are in the weighing position.

15. The weighing chute according to claim 10, further comprising a control device for checking measurements taken by the weighing sensors.

16. The weighing chute according to claim 15, wherein the control device comprises means for applying a predetermined force to the secondary frame when the weighing sensors are in the weighing position.

17. A facility for producing a rubber mixture, the facility comprising an internal mixer for producing a rubber mixture and the weighing chute according to claim 10 located under the internal mixer for weighing the mixture produced by the internal mixer.

18. The facility for producing a rubber mixture according to claim 17, wherein the main frame of the weighing chute is independent of a frame on which the internal mixer is mounted.
